(19) United States
(12) Patent Application Publication
(10) Pub. No.: US 2023/0004965 A1
(43) Pub. Date: Jan. 5, 2023

(54) METHOD AND SYSTEM, DEVICE AND PAYMENT TERMINAL USING PERSONAL DATA

(71) Applicant: BANKS AND ACQUIRERS INTERNATIONAL HOLDING, Paris (FR)

(72) Inventors: David NACCACHE, Paris (FR); Michel LEGER, Paris (FR); Elena TRICHINA, Aix en Provence (FR)

(21) Appl. No.: 17/784,745

(22) PCT Filed: Dec. 11, 2020
(86) PCT No.: PCT/FR2020/052395

§ 371 Date: Jun. 13, 2022

(30) Foreign Application Priority Data
Dec. 13, 2019 (FR) FR1914352

(51) Int. Cl. G06Q 20/38; G06Q 20/40; H04L 9/32

(52) U.S. Cl. CPC G06Q 20/3829; G06Q 20/3825; G06Q 20/388; G06Q 20/4014; G06Q 20/405; H04L 9/3226; H04L 9/3273; G06Q 20/40975

(57) ABSTRACT

The invention relates to an electronic transaction method for a system comprising a user-associated payment device 3 or 4 and a payment terminal 1. The payment device 3 or 4 and the payment terminal 1 perform a cryptographic key exchange 500 before performing a transaction step 501. The payment device includes personal information PI about the user. The payment terminal includes a transaction policy including a condition relative to the personal information Pi. The method includes a verification step 510, 520, 530, prior to the transaction step 501, for securely verifying the condition of the transaction policy relative to the personal information using the cryptographic key.

### TECHNICAL FIELD

The invention relates to a method, a system, a device and a payment terminal using personal data. More generally, the invention relates to an improvement of secure electronic payments.

### TECHNOLOGICAL BACKGROUND

An electronic transaction allows the sale or purchase of goods or services by using electronic payment means. This document relates more particularly to transactions initiated on a point of sale and made on a device provided with means to secure such transactions. To implement this type of transaction, a payment device stores payment identifiers, such as a bank card (magnetic, contact or contactless), a mobile phone or a smart watch, to be presented to a payment terminal which verifies that the payment means is authentic and validates the transaction. In the current transactions, only authentication of the payment means and the payment capacity are verified. There are numerous payment protocols. As a non-limiting example, the EMV (acronym of the initials of the founding companies Europay international, Mastercard international and Visa international) specifies the interoperability between bank cards and payment terminals by authorising numerous implementation variants: contact or contactless, with cash or credit payment, with or without PIN code, with variable security levels depending on the type of transaction or depending on the card issuer, etc.

In addition, payment conditions may be governed by certain personal data of a purchaser and certain transactions may also be legally prohibited depending on such personal data. When they exist, these transaction conditions are generally verified by a vendor during the purchase. Non-resident consumers may not want to pay certain taxes imposed on the sale of products, such as for example VAT (value added tax) in France. In this case, they must justify their status or submit a tax refund request after making a purchase. It may be necessary to verify the purchaser's age to obtain a price reduction or a purchase authorisation. This type of verification can only be carried out if a vendor is present or, if such a purchase is made on an automatic dispenser, by trusting the data indicated by the purchaser. A vendor may also omit to verify such personal data or be deceived by a malicious person, just like an automatic dispenser.

There is a need to be able to make transactions governed by personal data of a holder of payment means to apply a suitable price or authorise a transaction securely and automatically depending on personal data of a purchaser having electronic payment means.

### SUMMARY OF THE INVENTION

The invention proposes to improve the electronic transactions at a point of sale by securely verifying the authenticity of one or more items of personal information of a purchaser without the purchaser having to produce proof to a vendor. To this end, a payment device comprises at least one item of personal information which is submitted in a certified manner to a payment terminal. The payment terminal is designed to implement a transaction policy which takes into account one or more items of personal information to authorise or refuse to finalise a transaction.

The invention proposes an electronic transaction method between a payment device associated with a bank account of a user and a payment terminal associated with a bank account of a purchaser wherein the payment device and the payment terminal exchange at least one cryptographic key before performing a transaction step during which the transaction is validated or rejected. The payment device includes at least one item of personal information about the user. The payment terminal includes at least one transaction policy including a condition relative to the at least one item of personal information. The method includes a verification step, prior to the transaction step, for securely verifying the condition of the transaction policy relative to the personal information using the cryptographic key.

According to a first embodiment, the verification step may consist in the payment device sending the personal information together with a cryptographic signature made using the personal information and the cryptographic key to authenticate the personal information. The payment terminal may verify the condition of the transaction policy after authenticating the personal information.

According to a variant of this first embodiment, prior to sending the personal information, the payment terminal may send a request to the payment device asking it to send the personal information.

According to a second embodiment, the verification step may consist in the payment terminal sending a request to the payment device asking it to verify the transaction policy, the request being signed using the cryptographic key. The condition of the transaction policy may be verified by the payment device, after authenticating the request using the cryptographic key, which creates and transmits a validation or invalidation message to the payment terminal depending on the condition and the personal information.

According to a special embodiment, the transaction amount may be modified by the payment terminal depending on the result of the verification step.

Preferably, the cryptographic key may be exchanged during a mutual authentication step.

The invention also proposes an electronic transaction method implemented by a microprocessor of a payment device associated with a bank account of a user designed to cooperate with a payment terminal associated with a bank account of a purchaser to perform a transaction step during which the transaction is validated or rejected, said method including a step for exchanging at least one cryptographic key with the payment terminal. The payment device includes at least one item of personal information about the user, saved in a data memory. The method includes a verification step for securely verifying a condition of a transaction policy relative to the personal information using the cryptographic key.

According to a first embodiment, the verification step may include sending a message containing the personal information together with a cryptographic signature made using the personal information and the cryptographic key to authenticate said personal information.

According to a second embodiment, the verification step for verifying the condition of the transaction policy may include a prior step for authenticating a request issued by the payment terminal containing the condition of the transaction policy, the request being signed using the cryptographic key, and a step for sending a validation or invalidation message depending on the condition and the personal information.

The invention further proposes an electronic transaction method implemented by a microprocessor of a payment terminal, associated with a bank account of a purchaser, designed to cooperate with a payment device associated with a bank account of a user. Said method includes a step for exchanging at least one cryptographic key with the payment device and a transaction step during which the transaction is validated or rejected. The payment terminal includes at least one transaction policy including a condition relative to at least one item of personal information about the user of the payment device. The method includes a verification step for requesting the verification of the condition of the transaction policy relative to the personal information by using the cryptographic key, and the transaction step is implemented if and only if the condition is met.

According to a first embodiment, during the verification step, the method may include a step for receiving a message including the personal information together with a cryptographic signature made using the personal information and the cryptographic key and a step for verifying the condition of the transaction policy after authenticating the personal information using the cryptographic key.

According to a variant of this first embodiment, the method may include a step for creating and transmitting a request to the payment device to obtain the personal information.

According to a second embodiment, the verification step may consist in creating and transmitting a request to the payment device asking it to verify the transaction policy, the request being signed using the cryptographic key.

According to a special embodiment, the method may include a step for modifying the transaction amount depending on the result of the verification of the condition before validating the transaction.

According to another aspect, the invention proposes an electronic transaction system comprising a payment device associated with a bank account of a user and a payment terminal associated with a bank account of a purchaser wherein the payment device and the payment terminal are configured to exchange at least one cryptographic key before performing a transaction step during which the transaction is validated or rejected. The payment device includes at least one item of personal information about the user and the payment terminal includes at least one transaction policy including a condition relative to the at least one item of personal information. The payment device and the payment terminal are configured to perform a verification step between the step for exchanging the cryptographic key and the transaction step during which the condition of the transaction policy relative to the personal information is securely verified using the cryptographic key.

According to a first embodiment, the payment device can be configured to transmit to the payment terminal a message containing the personal information signed using the personal information and the cryptographic key to authenticate the personal information and the payment terminal can be configured to verify the condition after authenticating the personal information using the cryptographic key.

According to a variant of this first embodiment, the payment terminal can be configured to create and transmit a request to the payment device to obtain the personal information.

According to a second embodiment, the payment terminal can be configured to create and transmit to the payment device a request to verify the condition of the transaction policy signed using the cryptographic key. The payment device can be configured to authenticate said request using the cryptographic key before verifying the condition in response to the verification request and to return a validation or invalidation message to the payment terminal depending on the condition and the personal information.

According to a special embodiment, the payment terminal can be configured to modify the transaction amount depending on the result of the verification step.

The invention also proposes a payment device associated with a bank account of a user designed to cooperate with a payment terminal to perform an electronic transaction, said payment device being configured to exchange at least one cryptographic key with the payment terminal. The payment device includes at least one item of personal information about the user, and the payment device is configured to perform a step for securely verifying a condition of a transaction policy relative to the personal information using the cryptographic key.

According to a first embodiment, the payment device can be configured to send the personal information to the payment terminal in a message signed using the personal information and the cryptographic key to authenticate the personal information.

According to a second embodiment, the payment device can be configured to verify the condition of the transaction policy after receiving a verification request containing the condition, said request being signed and transmitted by the payment terminal using the cryptographic key, and to create and transmit a validation or invalidation message to the payment terminal depending on the condition and the personal information.

Preferably, the payment device can be a device selected from the following list: smart card complying with standard ISO7816 and/or standard 14443, mobile phone or tablet comprising a secure payment capacity, smart watch comprising payment features, secure computer comprising a contact or contactless communication interface and comprising a secure payment capacity.

The invention further proposes a payment terminal associated with a bank account of a purchaser designed to cooperate with a payment device associated with a bank account of a user to perform an electronic transaction wherein the payment terminal is configured to exchange at least one cryptographic key with the payment device before implementing a transaction step during which the transaction is validated or rejected. The payment terminal includes at least one transaction policy comprising a condition relative to at least one item of personal information saved in a memory of the payment device, said personal information being about the user. The payment terminal is configured to implement a verification step, prior to the transaction step, during which the condition of the transaction policy relative to the personal information is securely verified using the cryptographic key.

According to a first embodiment, the payment terminal can be configured to receive a message containing the personal information, signed by the payment device using the personal information and the cryptographic key. The payment terminal can be configured to verify the condition after authenticating the personal information using the cryptographic key.

As a variant of the first embodiment, the payment terminal can be configured to create and transmit a request to the payment device to obtain the personal information.

According to a second embodiment, the payment terminal can be configured to create and transmit to the payment device a request to verify the condition of the transaction policy signed using the cryptographic key. The payment terminal can be configured to end the transaction after receiving a validation or invalidation message returned by the payment device depending on the condition and the personal information.

According to a special embodiment, the payment terminal can be configured to modify the transaction amount depending on the result of the verification step.

Preferably, said payment terminal can be one of the following devices: point of sale terminal for smart card, mobile phone or tablet comprising a secure payment storage capacity, cash register comprising a secure payment storage capacity.

### BRIEF DESCRIPTION OF THE FIGURES

The invention will be easier to understand and other characteristics and advantages will appear on reading the description below of particular embodiments of the invention, given for illustration and as a non-limiting example, and referring to the attached drawings in which:

FIG. 1 shows an electronic payment system concerned by the invention,

FIG. 2 shows a smart card according to the invention,

FIG. 3 shows a mobile phone used as payment means according to the invention,

FIG. 4 shows a payment terminal according to the invention,

FIG. 5 shows a modified payment diagram according to a first embodiment of the invention,

FIG. 6 shows a modified payment diagram according to a second embodiment of the invention.

### DETAILED DESCRIPTION

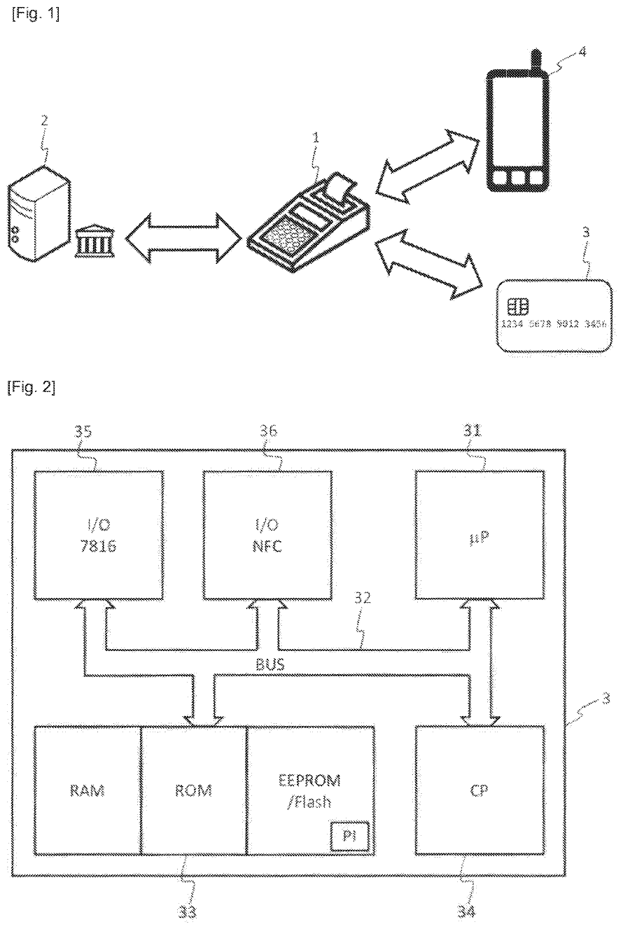

FIG. 1 shows a secure electronic payment system used according to the state of the art and used to implement the invention. The system of FIG. 1 includes a payment terminal 1 capable of communicating firstly with a bank server 2 and secondly with a payment device 3 or 4. This type of system is frequently used to perform payment operations from a point of sale, as defined in numerous payment service standards, for example in the EMV standard which is the most widely used and which includes numerous implementation possibilities. The payment terminal 1 may need to perform “offline” or “online” transactions, in other words disconnected from or connected to the bank server 2. The payment device 3 is traditionally a smart card 3 or a mobile phone 4, or any other electronic device capable of securely emulating the operation of a smart card, such as for example a smart watch which is an extension of a mobile phone in the form of a wrist watch, or any type of computer having the same capacities or features.

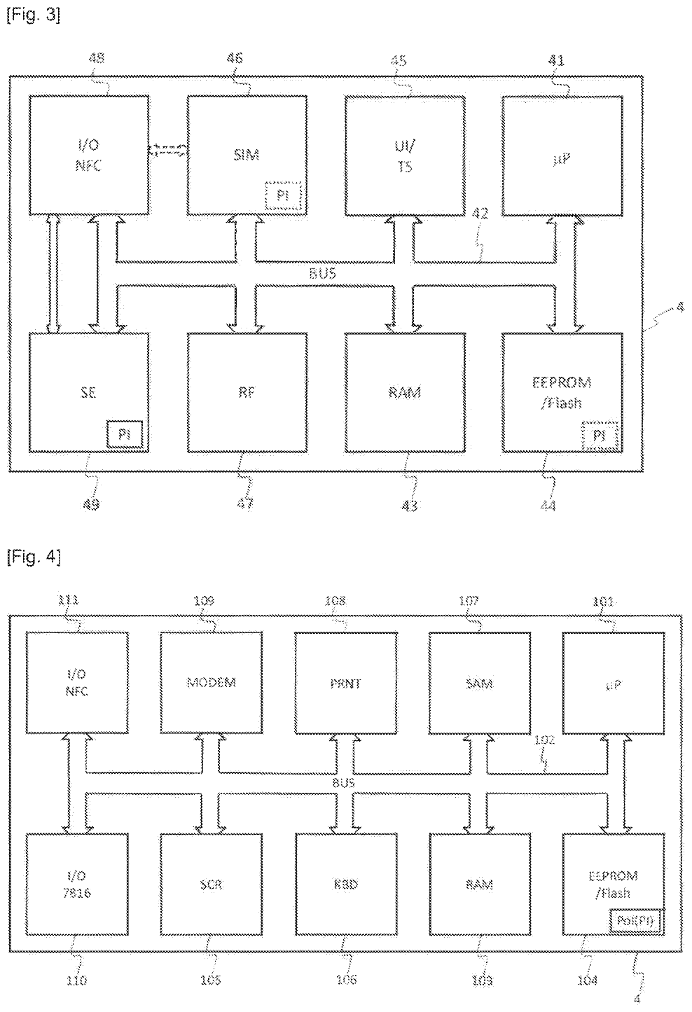

For example, FIG. 2 is a functional diagram of a bank card 3 or smart card which includes a microprocessor 31 controlling a central bus 32 to exchange data with a memory 33, a cryptoprocessor 34, a contact communication interface 35 and a contactless communication interface 36. The contact communication interface 35 is for example compatible with standard ISO7816. The contactless communication interface 36 is for example an NFC (Near Field Contactless) type communication interface, compatible with standard ISO14443. Although numerous payment card have these two types of communication interface 35 and 36, some cards have only one contact or contactless communication interface. For the invention, the smart card 3 must have at least one contact or contactless communication interface.

The memory 33 can be segmented in RAM (Random Access Memory) type volatile memory, ROM (Read-Only Memory) type program memory and EEPROM (Electrically-Erasable Programmable Read-Only Memory) or Flash type non-volatile memory. A secure operating system is implemented by the microprocessor 31 to guarantee the security of the information stored in the memory 33 of the smart card 3. Thus, the microprocessor 31 can authorise read or write access to some areas of the memory to commands from one of the communication interfaces 35 or 36. Other areas of the memory 33 can only be accessed by the microprocessor 31 or the cryptoprocessor 34. The microprocessor 31 can allow access to some data from the outside under certain conditions.

Numerous smart card architecture variants are known and those skilled in the art can use an architecture that is different from or similar to that described on FIG. 2. Nevertheless, those skilled in the art will make sure to use only card architectures that are sufficiently secure for application to the bank services and in particular in compliance with the specifications of a bank transaction standard, such as, given as a non-limiting example, the EMV standard.

According to the invention, personal information PI is stored in the non-volatile part of the memory 33 when the smart card is personalised in connection with data concerning a bank account to which the smart card is associated. The personal information PI concerns the bank account holder. It may concern their age, date of birth, place of residence or consist of any other personal information that may be used during a transaction according to the invention. The personal information PI can be stored in a memory area that can be read directly from one of the communication interfaces 35 or 36 while being write-protected so that it cannot be changed by an unauthorised person after being personalised. However, preferably, the personal information PI is stored in an area of the memory 33 that cannot be accessed directly from one of the communication interfaces 35 or 36. In a variant, the personal information PI cannot be accessed at all from the outside. The use of this personal information PI will be described later in this description.

FIG. 3 is a functional diagram of a mobile phone 4 that can be used as payment device. For example, the mobile phone 4 is a smartphone which includes a microprocessor 41 connected via a central bus 42 to a volatile memory 43, a non-volatile memory 44, a user interface 45, a SIM card 46, a radiocommunication interface 47, a proximity interface 48 and a secure element 49. The mobile phone 4 may also include other elements that are not shown since they do not concern the invention directly. For example, these other elements may include a microphone, a loudspeaker, a vibrator, a camera, a memory card reader, a wired communication interface of USB type for example, a battery or any other element that can be integrated in a mobile phone. In addition, the mobile phone 4 described on FIG. 3 corresponds to a preferred but non-limiting type of phone. In particular, as a variant, the mobile phone 4 might not include the secure element 49 or the SIM card 46.

The microprocessor 41 is the core of the mobile phone 4 which manages all the component elements via the central bus 42 by means of programs saved in the non-volatile memory 44 using the volatile memory 43 as working memory. The non-volatile memory 44 is composed for example of ROM type and EEPROM (Electrically-Erasable Programmable Read-Only Memory) type or Flash type memory. The programs stored include the operating system of the mobile phone 4 which manages the various features by using specific programs in order to produce various commands intended for the various elements of the phone 4. In the preferred embodiment according to FIG. 3 which includes the SIM card 46 and the secure element 49, the operating system is not secure as such since sensitive data and operations can be made secure in the SIM card 46 and/or in the secure element 49. According to a variant which does not include a SIM card 46, or a secure element 49, a secure operating system is required to restrict the read, write and execute accesses to some areas of the memory in order to guarantee the security of certain programs, in particular the bank transaction programs.

The user interface 45 is preferably a touchscreen which may also include a fingerprint reader. In a minimalistic variant, the user interface may simply consist of a display screen and a keyboard. Numerous other variants are also possible for those skilled in the art, without limiting the scope of the invention.

The SIM (Subscriber Identity Module) card 46 is generally used to store identifiers providing access to a mobile phone network (not shown) and to secure access to said network. The SIM card 46 is typically a smart card used to authenticate the phone on the phone network according to one of the telephony standards, such a card complying for example with standard ISO7816 and standard ETSI TS 102 221. According to the preferred embodiment, the SIM card 46 only performs its role of communicating with the mobile phone network.

The radiocommunication interface 47 is a multifrequency programmable radio interface provided with modulation, demodulation, encoding and decoding circuits that can be configured in different ways to communicate on a frequency band and according to a communication protocol chosen by the microprocessor 41 depending on information contained in the SIM card 46. This interface is compatible with several radio telephony standards, such as 2G, 3G, 4G and/or with shorter range radiocommunication standards, such as for example WiFi and Bluetooth. This radiocommunication interface can be used to exchange voice and data.

The proximity interface 48 is a CLF (Contactless Front-End) type interface as defined in standard ETSI TS 102 613, to allow the mobile phone to make NFC type communications, which are compatible with standard ISO14443. Using this interface, the mobile phone 4 can emulate the operation of a contactless smart card or a contactless smart card reader. This proximity interface is checked via the central bus 42 or by a specific communication port designed to be connected directly to a SIM card as defined in standard ETSI TS 102 613.

The secure element 49 is an independent integrated circuit which contains a secure processor, an execution memory and tamperproof storage like a smart card. The secure element 49 includes a first communication port connected to the central bus 42 and a second communication port connected to the specific communication port of the proximity interface 48. When the phone 4 is switched off, the secure element 49 can be powered directly by the proximity interface 48 from the electromagnetic field used for the communication. The secure element 49 can securely store data and programs. It can also execute them in complete security. This secure element 49 can contain and execute secure programs similar to those that can be executed by the smart card 3 described previously, in particular to perform payment operations. According to a preferred embodiment, the secure element contains the personal information PI.

According to variant in which the mobile phone 4 does not have a secure element 49, the SIM card 46 can be a multi-application card containing a banking application and the personal information PI. To this end, the SIM card may comply with standard ETSI TS 102 613 and have a direct link to the proximity interface 48 via its specific communication port or exchange data with the payment terminal 1 via the radiocommunication interface 47. The SIM card 46 can thus replace the secure element 49 and perform in its place the various functions described previously.

According to another variant, the mobile phone 4 does not include a secure element 49 or a SIM card 46. According to this variant, the phone 4 includes a secure operating system, a banking application program and the personal information PI is stored in a protected area of the non-volatile memory 44.

As an alternative, the mobile phone 4 can be replaced by any other electronic device comprising a microprocessor provided with all or some of the elements described in relation with FIG. 3. As a non-limiting example, such a device may be a tablet, a smart watch or a laptop. The electronic device must nevertheless have a secure capacity to read, write and execute programs and data in order to receive a secure payment application and a contact or contactless communication interface in order to communicate with the payment terminal 1.

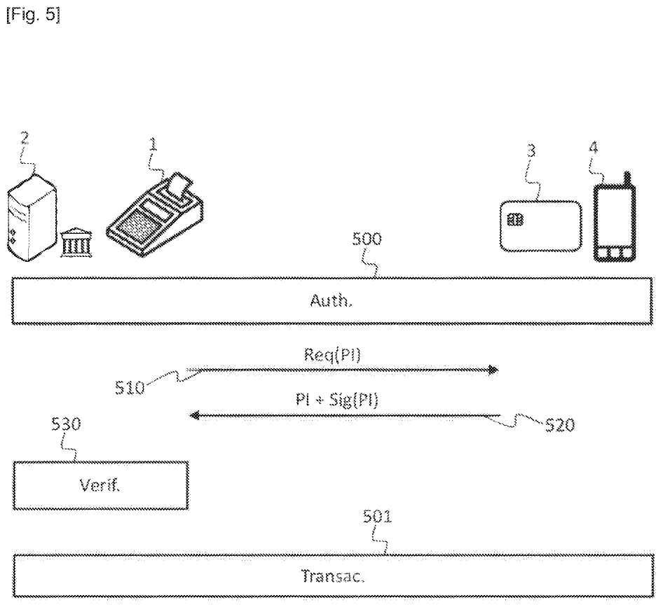

FIG. 4 is a functional diagram of a payment terminal 1 designed to receive payments in the form of electronic transactions. The payment terminal 1 may be a secure POS (Point Of Sale) terminal, in other words included in a box structurally reinforced against any malicious attempt to damage it but may also be installed in an automatic product dispenser or be included in a store cash register, or be emulated on a smartphone.

As a non-limiting example, the payment terminal 1 includes a microprocessor 101 connected via a central bus 102 to a volatile memory 103, a non-volatile memory 104, a screen 105, a keyboard 106, a SAM card 107, a printer 108, a contact and/or contactless communication interface 109, a contact smart card reader 110, a proximity communication interface 111. The payment terminal 1 may also include other elements that are not shown since they do not concern the invention directly. For example, these other elements may comprise a battery, a SIM card, a memory card reader or any other element that can be integrated in a payment terminal. In addition, the payment terminal 1 described corresponds to a preferred but non-limiting POS type terminal. As a variant, in particular, the payment terminal 1 may be simplified or emulated on a secure mobile phone and not include a proximity communication interface 111, a smart card reader 110, a printer 108 or a SAM card 107. In addition, the screen 105 and the keyboard 106 can be replaced by a touchscreen or any other type of human-machine interface used to interact with a user.

The microprocessor 101 is the core of the payment terminal 1 which manages all the component elements via the central bus 102 by means of programs stored in the non-volatile memory 104 using the volatile memory 103 as working memory. The non-volatile memory 104 is composed for example of ROM type and EEPROM (Electrically-Erasable Programmable Read-Only Memory) type or Flash type memory. The programs saved in the non-volatile memory 104 include for example a secure operating system implemented by the microprocessor 101 to guarantee the security of the information stored in the memory 104. Thus, read and/or write access to some memory areas is only possible under the control of the microprocessor 101, via one of the communication interfaces 109.

The non-volatile memory 104 also stores programs that can be executed by the microprocessor 101 to perform banking transactions. These programs include a certain number of sub-programs designed to manage various transaction options which depend on the type of bank card, the bank card issuer and also special parameters which can, for example, be defined by a merchant using said payment terminal 1. Some of the sub-programs may respectively concern transaction policies which define special payment conditions, for example electronic verifications to be performed depending on the type of card, a payment threshold above which the bank must be contacted to authorise or refuse the transaction, conditions relative to entering or typing a verification code or additional verifications that can be configured by the merchant using said terminal 1

Users of the payment terminal 1 use the screen 105 to display information when executing a transaction. The keyboard 106 is used to indicate transaction information to the payment terminal 1, such as for example the transaction amount, or to enter a PIN (Personal Identification Number) code. The printer 108 is used to print a transaction receipt intended for the purchaser and/or the merchant. In a variant, the printer 108 is not included and the transaction receipt can be sent as an electronic message to each party of the transaction or to another machine connected to the payment terminal 1 which will print the receipt instead of said terminal 1.

The SAM card 107 is a Secure Access Module or Secure Application Module. The SAM card guarantees the security of the transaction and of the sensitive information of the payment terminal 1. The SAM card 107 can store and produce cryptographic keys and/or implement cryptographic calculation algorithms required to implement a security policy, for example to perform a strong authentication process carried out during a transaction. The SAM card 107 is a smart card inserted into an internal reader (not shown) of the payment terminal 1. According to a variant, the SAM card 107 can be replaced by a secure element or by the microprocessor 101 if the latter includes a cryptographic processor and a secure operating system to guarantee sufficient security for the sensitive information.

The communication interface 109 allows the terminal to communicate with the bank server 2. Depending on the type of payment terminal 1, such a communication interface 109 traditionally manages “wired” communications, for example according to the Internet protocol and/or radiocommunication type communications, for example according to a 3G or 4G radiotelephony protocol. The communications made via the communication interface 109 are preferably encrypted by the SAM card 107. According to a variant, a payment device 4 can communicate with a payment terminal 1 via the communication interface 109.

The smart card reader 110 complies with standard ISO7816 to receive a bank card 3 and communicate with it via electrical contacts. The proximity interface 111 is a contactless card reader complying with standard ISO14443 used to communicate with a bank card 3 or any other contactless payment device 4 having a proximity interface compatible with said standard ISO14443.

According to a preferred embodiment of the invention, the memory 104 of the payment terminal 1 stores one or more sub-programs corresponding to one or more transaction policies Pol(PI) to process the personal information PI stored in the payment device 3 or 4. Such transaction policies can be justified from a legal point of view or from a commercial point of view. Each transaction policy Pol(PI) includes a condition relative to personal information PI which governs the performance of a transaction depending on whether or not said condition is met by said personal information PI. By verifying that the personal information PI meets the condition of the transaction policy Pol(PI), the payment terminal 1 avoids the need to prove to a vendor that this information is true, for example by producing an identity document. Transactions governed by personal information can thus be performed without a vendor having to be present, and this type of transaction can therefore be performed using dispensing machines.

Some policies used to verify personal information are indicated as non-limiting examples. A first transaction policy Pol(PI) may concern a minimum age of the holder of the payment device in order to perform a transaction on a product whose distribution is legally restricted. For example, a sale may be refused to a minor. This first policy allows, for example, a cigarette or alcoholic beverage dispenser to verify the customer's age without a person having to be present to perform said verification. A second transaction policy Pol(PI) may concern a commercial discount depending on the age of the person as part of a sales promotion to privilege young or senior customers. For example, if the card holder is under twenty-five or over sixty-five, the payment terminal 1 can verify the personal information PI corresponding to the age of the holder of the payment device and calculate a ten percent discount on a transaction amount. A third transaction policy Pol(PI) may consist in not taxing foreigners to avoid subsequent tax refund operations. With this third policy, the payment terminal 1 may, for example, verify personal information PI corresponding to the country of residence of the holder of the payment device and deduct the amount of the taxes if the personal information PI corresponds to a country for which the tax refund applies. The address may also be used for commercial purposes in a fourth transaction policy Pol(PI) which generates commercial discounts for persons living in geographic areas covered by sales promotions. According to this fourth policy, the terminal verifies personal information PI corresponding to the address or post code of the holder of the payment device, then calculates a commercial discount if the address of residence corresponds to a geographic area covered by a sales promotion. Numerous other policies can be considered, provided that certain items of personal information are present in the payment device. Numerous variants can be considered, provided that a transaction can be governed by personal information PI.

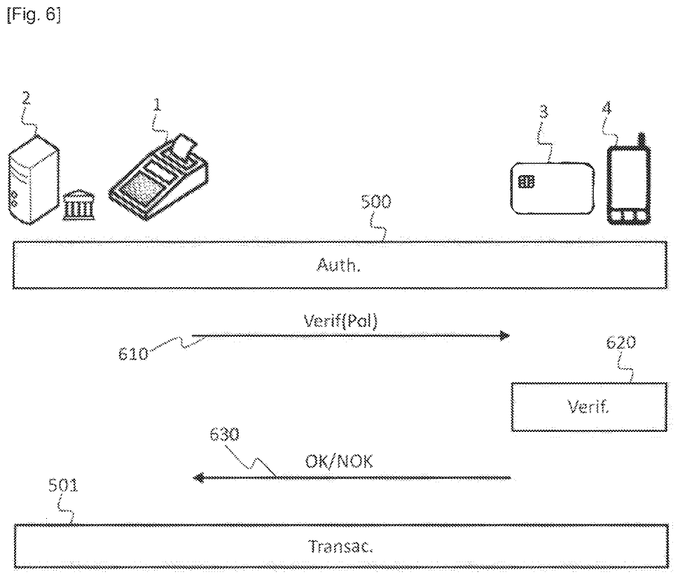

Several methods are available to verify that the personal information PI meets the condition of the transaction policy Pol(PI). According to the invention, the authenticity of the personal information PI is verified before verifying that it meets said condition. FIGS. 5 and 6 show two verification techniques. For these two FIGS. 5 and 6, the payment terminal 1 and the bank server 2 are considered together. For some authentication operations, in fact, the payment terminal 1 becomes “transparent” and only acts as relay or gateway between a payment device 3 or 4 and the bank server 2. For the descriptions of FIGS. 5 and 6, a smart card reader type payment terminal 1 is considered in connection with a bank card type payment device 3. All the variants of the bank terminal or of the payment terminal 3 or 4 can nevertheless replace the system described.

FIG. 5 describes a first example of a method for using the personal information. The payment terminal 1 and the payment device 3 implement their respective transaction programs including the sub-programs relating to the various steps of the method which will be described and in particular the sub-programs relating to the implementation of the transaction policies Pol(PI). In this first example, the payment terminal 1 and the payment device 3 perform a mutual authentication step 500, as defined in a bank payment protocol, for example the EMV protocol. During this mutual authentication step 500, the payment device 3 and the payment terminal 1 can exchange public keys, certificates, a secret, perform a challenge, determine a session key and, possibly, exchange a PIN code. This authentication step 500 is performed, firstly, to allow the payment terminal 1 to verify that the payment device 3 is an authorised payment device and, secondly, to allow the payment device 3 to verify that the payment terminal 1 is an authorised payment terminal and, optionally, that the holder of the payment device validates the transaction on the payment terminal 1. For more details, those skilled in the art will refer to the various existing payment transaction standards. In the framework of the invention, any transaction standard can replace the EMV standard and there is no need for mutual authentication provided that at least one cryptographic key is exchanged between the payment terminal 1 and the payment device 3.

According to the state of the art, a transaction step 501 follows the mutual authentication step 500. During the transaction step 501, the payment terminal 1 and the payment device 3 exchange transaction data such as for example the transaction amount, and each executes an offline risk analysis sub-program, possibly as well as an online risk analysis by communicating with the bank server 2, then finalise the transaction either by refusing or accepting it, and by each one storing the transaction performed.

According to the invention, a verification step for verifying the personal information PI is added between the mutual authentication step 500 and the transaction step 501. The transaction policy Pol(PI) can then be applied before or during the transaction step 501. In the example of FIG. 5, the payment terminal 1 sends a request 510 to the payment device 3 asking it to send one or more items of personal information PI. Following this request 510, the payment device 3 sends an answer 520 containing the requested personal information PI together with data Sig(PI) authenticating the personal information PI. The payment terminal 1 then verifies the data authenticating the personal information PI in a step 530 and, if said information is authenticated, verifies that the personal information meets the condition of the transaction policy Pol(PI). The transaction policy Pol(PI) is then applied, depending on the verification, before or during the transaction step 501.

The request of 510 can be sent in several ways, or even be sent implicitly. According to a first embodiment complying with the EMV protocol, the request 510 is not sent. During the mutual authentication step 500, information relative to the possibilities of the payment terminal 1 can be sent to the payment device 3 so that the latter is informed of the protocol to be applied regarding the payment terminal 1. As part of the information sent, the payment terminal 1 indicates that an item of personal data PI is required to finalise the transaction. After the mutual identification step 500, the payment terminal 1 performs a hot reset of the payment device 3. Following the reset signal, the payment device 3 issues an answer 520 which corresponds to an ATR (Answer To Reset) type message together with the personal information PI and a signature Sig(PI) of the personal information PI. Preferably, the signature Sig(PI) is a cryptographic signature of the personal data PI, for example a signature as defined in the PKCS #1 standard using a cryptographic key which can be a common encryption key or a public key encryption structure, shared by the payment device 3 and the payment terminal 1. Numerous types of signature are possible, including as an additional but non-limiting example a MAC (Message Authentication Code) as defined in the publication RFC 2104: “HMAC: Keyed-Hashing for Message Authentication” can also be used. The most important being that the cryptographic key used by the payment device 3 allows the payment terminal 1 to verify the authenticity of the personal data PI during step 530. Once the personal information PI is considered to be authentic, the payment terminal verifies whether said personal information PI meets the condition of the transaction policy Pol(PI).

According to a second embodiment, the payment terminal 1 sends a request 510 as an APDU (Application Protocol Data Unit) type command defined in standard ISO7816 to read the personal information PI. Amongst the APDU commands that can be used for the request 510, those skilled in the art can use, as non-limiting examples, the GET_DATA, READ_BINARY and READ_RECORD commands to read information in a payment device 3. In response to one of these commands identifying the personal information PI or an area containing said information PI, the payment device replies by sending an answer message 520 containing the personal information PI together with a certificate or a cryptographic signature Sig(PI) so that the payment terminal can authenticate said personal information PI during step 530. The certificate or the cryptographic signature is produced, for example, according to one of the techniques described previously. Once the personal information PI is considered to be authentic, the payment terminal verifies whether said personal information PI meets the condition of the transaction policy Pol(PI).

FIG. 6 shows a second example of a method for using the personal information PI. The payment terminal 1 and the payment device 3 implement their respective transaction programs including the sub-programs relating to the various steps of the method which will be described and in particular the sub-programs relating to the implementation of the transaction policies Pol(PI). In this second example, the payment terminal 1 and the payment device 3 perform a mutual authentication step 500 and a transaction step 501, as previously defined according to an electronic payment protocol. A verification of the personal information PI is added between the mutual authentication step 500 and the transaction step 501 before applying the transaction policy before or during the transaction step 501. In the framework of the invention, any transaction standard can replace the EMV standard and there is no need for mutual authentication provided that at least one cryptographic key is exchanged between the payment terminal 1 and the payment device 3.

In this second example, the payment terminal 1 sends a request 610 to the payment device 3 asking it to verify the personal information PI, indicating a condition to be met regarding the personal information PI to apply the transaction policy Pol(PI). During a step 620, the payment device 3 verifies that the personal information PI meets the condition sent in the request 610. The payment device 3 sends an answer 630 to the payment terminal 1 containing the result of the verification. The payment terminal 1 then applies the transaction policy Pol(PI) depending on the result of the verification, before or during the transaction step 501. Thus, the personal information PI can remain confidential since the only information given is that the personal information PI meets the condition of the transaction policy.

The verification request 610 can be sent using a VERIFY type APDU having a certain number of data fields which specify the personal information PI to be verified and the condition of the transaction policy Pol(PI). In addition, to guarantee the confidentiality of the personal data, the request 610 may also include a signature produced using a cryptographic key shared by the payment terminal 1 and the payment device 3. The signature is produced for example on all the bits of the request which correspond to the condition. The condition may include a value and a relation between the value and the personal information PI. For example, for personal information PI corresponding to an age or a date of birth, the value can be the limiting age or date of birth and the relation can be a comparison with this age or date or birth such as “less than” or “greater than”. If the personal information is a place of residence, for example a country, a post code or an address, the relation may be of type “equal to” or “different from”.

After receiving the request 610, the payment device 3 implements a verification sub-program during step 620. Thus, the payment device checks that the signature of the request 610 meets the requested condition. This first verification ensures that the request has been issued by the payment terminal 1 which is considered as a device authorised to perform such a verification. Once the request has been successfully verified, the microprocessor 31 of the payment device 3 reads in its memory 33 the personal information PI specified in the request 610. The payment device 3 then performs the requested comparison of the personal information PI with the value indicated. After making the comparison, the payment device then prepares and sends an answer 630 corresponding to the result of said comparison. The result is binary, in other words the condition is met or the condition is not met and the answer 630 may correspond to a message in response to the VERIFY command validating or not the comparison made securely. Optionally, the answer may also be signed using the cryptographic key. The payment terminal 1 then applies the transaction policy Pol(PI) depending on the result of the verification, before or during the transaction step 501.

Those skilled in the art may notice that the second embodiment of the invention also allows the personal information PI to be kept in the payment device. The personal information PI which may be sensitive information, for example the holder's address, therefore remains confidential.

In other embodiments, several items of personal information may be present in the payment device 3 and several transaction policies Pol(PI) may be used during a given transaction. According to a special embodiment, steps 510 to 530 or 610 to 630 can be repeated as many times as required. According to another embodiment, more complex commands concerning several items of personal information and/or several conditions can be used simultaneously.

In the examples of FIGS. 5 and 6, the APDUs used must be defined both in the payment device 3 and in the payment terminal 1. Those skilled in the art will therefore understand that such features must be encoded and standardised in order to use them.

According to a variant, communication interfaces complying with standards ISO7816 or ISO14443 do not have to be used. This is the case in particular when the payment device is a mobile phone 4. In this case, the transaction can be performed using a radiofrequency communication protocol, for example complying with standard IEEE 802.11 more widely known as WiFi. The transaction can be made secure by using, for example, a channel encrypted using a transaction method similar to that described previously. The embodiments described using FIGS. 5 and 6 can be applied in the same way, taking into account the fact that the messages between the payment terminal 1 and the mobile phone 4 will be exchanged according to another data exchange protocol which does not necessarily use APDUs.

Irrespective of the embodiment, certifying the personal information PI guarantees, for the transaction, that the information is authentic. Thus, the personal information PI is stored in the payment device 3 by an authorised third party, such as for example a bank, and the certification carried out by the payment device is equivalent to a certification by the authorised third party.

1. An electronic transaction method between a payment device associated with a bank account of a user and a payment terminal associated with a bank account of a purchaser wherein the payment device and the payment terminal exchange at least one cryptographic key before performing a transaction step during which the transaction is validated or rejected, characterised in that:
the payment device includes at least one item of personal information about the user;
the payment terminal includes at least one transaction policy including a condition relative to the at least one item of personal information;
and in that the method includes a verification step, prior to the transaction step, for securely verifying the condition of the transaction policy relative to the personal information using the cryptographic key.

2. The method according to claim 1, wherein the verification step consists in the payment device sending the personal information together with a cryptographic signature made using the personal information and the cryptographic key to authenticate the personal information and in the payment terminal verifying the condition of the transaction policy after authenticating the personal information.

3. The method according to claim 2, wherein, prior to sending the personal information, the payment terminal sends a request to the payment device asking it to send the personal information.

4. The method according to claim 1, wherein the verification step consists in the payment terminal sending a request to the payment device asking it to verify the transaction policy, the request being signed using the cryptographic key, and in the condition of the transaction policy being verified by the payment device, after authenticating the request using the cryptographic key, which creates and transmits a validation or invalidation message to the payment terminal depending on the condition and the personal information.

5. The method according to claim 1, wherein a transaction amount is modified by the payment terminal depending on a result of the verification step.

6. The method according to claim 1, wherein the cryptographic key is exchanged during a mutual authentication step.

7. An electronic transaction method implemented by a microprocessor of a payment device associated with a bank account of a user designed to cooperate with a payment terminal associated with a bank account of a purchaser to perform a transaction step during which the transaction is validated or rejected, said method including a step for exchanging at least one cryptographic key with the payment terminal, characterised in that the payment device includes at least one item of personal information about the user, saved in a data memory, and in that the method includes a verification step for securely verifying a condition of the transaction policy relative to the personal information using the cryptographic key.

8. The method according to claim 7, wherein the verification step includes sending a message containing the personal information together with a cryptographic signature made using the personal information and the cryptographic key to authenticate said personal information.

9. The method according to claim 7, wherein the verification step for verifying the condition of the transaction policy includes a prior step for authenticating a request issued by the payment terminal containing the condition of the transaction policy, the request being signed using the cryptographic key, and a step for sending a validation or invalidation message depending on the condition and the personal information.

10. An electronic transaction method implemented by a microprocessor of a payment terminal, associated with a bank account of a purchaser, designed to cooperate with a payment device associated with a bank account of a user, said method including a step for exchanging at least one cryptographic key with the payment device, a transaction step during which the transaction is validated or rejected, characterised in that the payment terminal includes at least one transaction policy including a condition relative to an at least one item of personal information about the user of the payment device, in that the method includes a verification step for requesting the verification of the condition of the transaction policy relative to the personal information by using the cryptographic key, and in that the transaction step is implemented if and only if the condition is met.

11. The method according to claim 10, wherein, during the verification step, the method includes a step for receiving a message including the personal information together with a cryptographic signature made using the personal information and the cryptographic key and a step for verifying the condition of the transaction policy after authenticating the personal information using the cryptographic key.

12. The method according to claim 10, the method including a step for creating and transmitting a request to the payment device to obtain the personal information.

13. The method according to claim 10, wherein the verification step consists in creating and transmitting a request to the payment device asking it to verify the transaction policy, the request being signed using the cryptographic key.

14. The method according to claim 10, the method including a step for modifying a transaction amount depending on a result of the verification of the condition before validating the transaction.

15. A electronic transaction system comprising a payment device associated with a bank account of a user and a payment terminal associated with a bank account of a purchaser, wherein the payment device and the payment terminal are configured to exchange at least one cryptographic key before performing a transaction step during which the transaction is validated or rejected, characterised in that the payment device includes at least one item of personal information about the user and the payment terminal includes at least one transaction policy including a condition relative to the at least one item of personal information, and in that the payment device and the payment terminal are configured to perform a verification step between the step for exchanging the cryptographic key and the transaction step during which the condition of the transaction policy relative to the personal information is securely verified using the cryptographic key.

16. The system according to claim 15, wherein the payment device is configured to transmit to the payment terminal a message containing the personal information signed using the personal information and the cryptographic key to authenticate the personal information and wherein the payment terminal is configured to verify the condition after authenticating the personal information using the cryptographic key.

17. The system according to claim 16, wherein the payment terminal is configured to create and transmit a request to the payment device to obtain the personal information.

18. The system according to claim 15, wherein the payment terminal is configured to create and transmit to the payment device a request to verify the condition of the transaction policy signed using the cryptographic key and wherein the payment device is configured to authenticate said request using the cryptographic key before verifying the condition in response to the verification request and to return a validation or invalidation message to the payment terminal depending on the condition and the personal information.

19. The system according to claim 15, wherein the payment terminal is configured to modify a transaction amount depending on a result of the verification step.

20. A payment device associated with a bank account of a user designed to cooperate with a payment terminal to perform an electronic transaction, said payment device being configured to exchange at least one cryptographic key with the payment terminal, characterised in that the payment device includes at least one item of personal information about the user, and in that the payment device is configured to perform a step for securely verifying a condition of a transaction policy relative to the personal information using the cryptographic key.

21. The device according to claim 20, wherein the payment device is configured to send the personal information to the payment terminal in a message signed using the personal information and the cryptographic key to authenticate the personal information.

22. The device according to claim 20, wherein the payment device is configured to verify the condition of the transaction policy after receiving a verification request containing the condition, said request being signed and transmitted by the payment terminal using the cryptographic key, and to create and transmit a validation or invalidation message to the payment terminal depending on the condition and the personal information.

23. The device according to claim 20, wherein the payment device is one of the following devices: smart card complying with standard ISO7816 and/or standard 14443, mobile phone or tablet comprising a secure payment capacity, smart watch comprising payment features, secure computer comprising a contact or contactless communication interface and comprising a secure payment capacity.

24. A payment terminal associated with a bank account of a purchaser designed to cooperate with a payment device associated with a bank account of a user to perform an electronic transaction wherein the payment terminal is configured to exchange at least one cryptographic key with the payment device before implementing a transaction step during which the transaction is validated or rejected, characterised in that the payment terminal includes at least one transaction policy comprising a condition relative to at least one item of personal information saved in a memory of the payment device, said personal information being about the user, and in that the payment terminal is configured to implement a verification step, prior to the transaction step, during which the condition of the transaction policy relative to the personal information is securely verified using the cryptographic key.

25. The terminal according to claim 24, wherein the payment terminal is configured to receive a message containing the personal information signed by the payment device using the personal information and the cryptographic key and wherein the payment terminal is configured to verify the condition after authenticating the personal information using the cryptographic key.

26. The terminal according to claim 25, wherein the payment terminal is configured to create and transmit a request to the payment device to obtain the personal information.

27. The terminal according to claim 24, wherein the payment terminal is configured to create and transmit to the payment device a request to verify the condition of the transaction policy signed using the cryptographic key and wherein the payment terminal is configured to end the transaction after receiving a validation or invalidation message returned by the payment device depending on the condition and the personal information.

28. The terminal according to claim 24, wherein the payment terminal is configured to modify a transaction amount depending on a result of the verification step.

29. The terminal according to claim 24, wherein said payment terminal is one of the following devices: point of sale terminal for smart card, mobile phone or tablet comprising a secure payment storage capacity, cash register comprising a secure payment storage capacity.
